(19) United States
(12) Patent Application Publication
(10) Pub. No.: US 2025/0233972 A1
(43) Pub. Date: Jul. 17, 2025

(54) INFORMATION PROCESSING SYSTEM, INFORMATION PROCESSING METHOD, AND NON-TRANSITORY COMPUTER-READABLE MEDIUM

(71) Applicant: CANON KABUSHIKI KAISHA, Tokyo (JP)

(72) Inventors: Toshinori HIROBE, Kanagawa (JP); Tomohiro YANO, Kanagawa (JP)

(21) Appl. No.: 19/007,629

(22) Filed: Jan. 2, 2025

(30) Foreign Application Priority Data
Jan. 11, 2024 (JP) 2024-002795

(51) Int. Cl. H04N 13/279; G06T 17/00; H04N 13/383

(52) U.S. Cl. CPC H04N 13/279; G06T 17/00; H04N 13/383

(57) ABSTRACT

An information processing system is provided. The system obtains three-dimensional models of one or more objects at a designated time from a storage that stores three-dimensional models indicating three-dimensional shapes of objects at respective times. The system, using the three-dimensional models of the one or more objects at the designated time, generates a virtual viewpoint image corresponding to the designated time from a virtual viewpoint based on a designated virtual viewpoint parameter. The system outputs the generated virtual viewpoint image. The system determines whether a predetermined condition is satisfied, the predetermined condition being a condition related to at least one of the time and the virtual viewpoint parameter. The system, in response to satisfaction of the predetermined condition, records information on the three-dimensional models of the objects corresponding to the generated virtual viewpoint image.

### BACKGROUND

### Field

The present disclosure relates to an information processing system, an information processing method, and a non-transitory computer-readable medium, and especially to a virtual viewpoint image technology.

### Description of the Related Art

A technique to generate a virtual viewpoint image of a subject from a designated virtual viewpoint is drawing attention. Such a virtual viewpoint image can be generated using a plurality of images obtained through image capture performed by a plurality of image capturing apparatuses as indicated by, for example, Japanese Patent Laid-Open No. 2015-45920. Such a virtual viewpoint image can be generated based on three-dimensional models representing a three-dimensional shape of a subject. The three-dimensional models can be generated based on a plurality of images. Regarding a method of generating the three-dimensional models, for example, a method described in Moezzi (S. Moezzi et al. “Virtual View Generation for 3D Digital Video”, IEEE Multimedia, Vol. 4, Issue 1, pp. 18-26 (1997)) is known.

### SUMMARY

According to an embodiment, an information processing system comprises one or more memories storing instructions and one or more processors that execute the instructions to: obtain three-dimensional models of one or more objects at a designated time from a storage that stores three-dimensional models indicating three-dimensional shapes of objects at respective times; using the three-dimensional models of the one or more objects at the designated time, generate a virtual viewpoint image corresponding to the designated time from a virtual viewpoint based on a designated virtual viewpoint parameter; output the generated virtual viewpoint image; determine whether a predetermined condition is satisfied, the predetermined condition being a condition related to at least one of the time and the virtual viewpoint parameter; and in response to satisfaction of the predetermined condition, record information on the three-dimensional models of the objects corresponding to the generated virtual viewpoint image.

According to another embodiment, an information processing system comprises one or more memories storing instructions and one or more processors that execute the instructions to: obtain a three-dimensional model that is an inspection target; with reference to a record of generation of a virtual viewpoint image, obtain, as a three-dimensional model that is a comparison target, a three-dimensional model that has been used to generate the virtual viewpoint image in the past from a storage that stores three-dimensional models indicating three-dimensional shapes of objects; and compare the three-dimensional model that is the inspection target with the three-dimensional model that is the comparison target.

According to still another embodiment, an information processing method comprises: obtaining three-dimensional models of one or more objects at a designated time from a storage that stores three-dimensional models indicating three-dimensional shapes of objects at respective times; with use of the three-dimensional models of the one or more objects at the designated time, generating a virtual viewpoint image corresponding to the designated time from a virtual viewpoint based on a designated virtual viewpoint parameter; outputting the generated virtual viewpoint image; determining whether a predetermined condition is satisfied, the predetermined condition being a condition related to at least one of the time and the virtual viewpoint parameter; and in response to satisfaction of the predetermined condition, recording information on the three-dimensional models of the objects corresponding to the generated virtual viewpoint image.

According to yet another embodiment, a non-transitory computer-readable medium stores a program executable by a computer to perform a method comprising: obtaining three-dimensional models of one or more objects at a designated time from a storage that stores three-dimensional models indicating three-dimensional shapes of objects at respective times; with use of the three-dimensional models of the one or more objects at the designated time, generating a virtual viewpoint image corresponding to the designated time from a virtual viewpoint based on a designated virtual viewpoint parameter; outputting the generated virtual viewpoint image; determining whether a predetermined condition is satisfied, the predetermined condition being a condition related to at least one of the time and the virtual viewpoint parameter; and in response to satisfaction of the predetermined condition, recording information on the three-dimensional models of the objects corresponding to the generated virtual viewpoint image.

Further features of the present disclosure will become apparent from the following description of exemplary embodiments (with reference to the attached drawings).

### BRIEF DESCRIPTION OF THE DRAWINGS

FIG. 1 is a block diagram showing an example of a configuration of an information processing system according to an embodiment.

FIG. 2 is a diagram showing an example of a data structure of information recorded in a model recording unit 134.

FIG. 3 is a flowchart showing an example of an information processing method according to an embodiment.

FIG. 4 is a flowchart showing an example of an information processing method according to an embodiment.

FIG. 5 is a diagram showing an example of information recorded in a memory of a determination unit 142.

FIG. 6 is a diagram showing an example of a data structure of information recorded in an information recording unit 143.

FIG. 7 is a diagram showing an example of a data structure of information recorded in the information recording unit 143.

FIG. 8 is a flowchart showing an example of an information processing method according to an embodiment.

FIG. 9 is a diagram showing an example of a hardware configuration of a computer used in an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but all such features are not necessarily required, and multiple such features may be combined as appropriate. Furthermore, in the attached drawings, the same reference numerals are given to the same or similar configurations, and redundant description thereof is omitted.

As disclosed in Japanese Patent Laid-Open No. 2015-45920, virtual viewpoint images from various virtual viewpoints can be generated based on a three-dimensional shape of a subject estimated based on a plurality of images. Meanwhile, a user of an apparatus that generates such virtual viewpoint images can generate virtual viewpoint images from a plurality of virtual viewpoints. A three-dimensional shape of a subject can be estimated by using the virtual viewpoint images thus generated, which are respectively from different virtual viewpoints. In other words, this allows a third party to obtain a copy of data indicating the three-dimensional shape. However, for a business operator that provides various virtual viewpoint image contents, it is not desirable to allow copies of data indicating the three-dimensional shape, which is used in generation of virtual viewpoint images, to be freely made.

The present disclosure provides a technique to reduce the amount of recorded data used to estimate whether a three-dimensional shape of an inspection target is a copy that has been made based on a generated virtual viewpoint image.

### (Generation of Virtual Viewpoint Image)

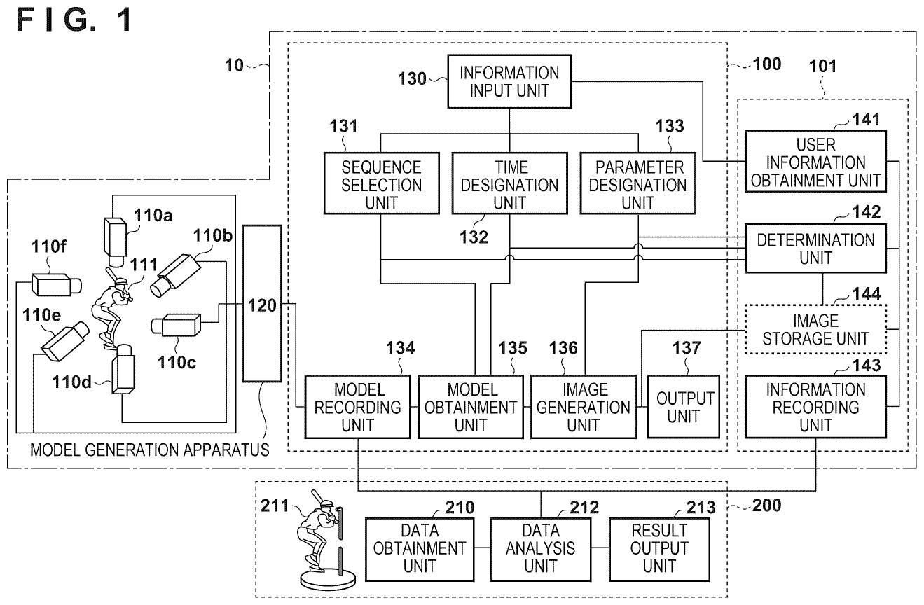

FIG. 1 is a configuration diagram of an image generation system 10, which is an information processing system according to an embodiment. This image generation system can generate virtual viewpoint images. The image generation system 10 includes a camera group 110, a model generation apparatus 120, an image generation apparatus 100, and an information processing apparatus 101. Note that an information processing system according to an embodiment need not include all of these apparatuses. For example, an information processing system according to an embodiment includes the image generation apparatus 100 and the information processing apparatus 101. Also, an information processing system according to an embodiment need not include all of the processing units described below. For example, an information processing system according to an embodiment includes a model obtainment unit 135, an image generation unit 136, an output unit 137, a determination unit 142, and an information recording unit 143.

The camera group 110 includes a plurality of cameras (e.g., cameras 110a to 110f). The camera group 110 captures a subject 111 from different directions. Then, the camera group 110 inputs each image to the model generation apparatus 120.

The model generation apparatus 120 generates information indicating a three-dimensional shape of an object. For example, the model generation apparatus 120 can generate a three-dimensional model indicating a three-dimensional shape of the subject 111. The model generation apparatus 120 can generate the three-dimensional model using the plurality of images input by the camera group 110. A method of generating the three-dimensional model is not limited in particular. For example, the model generation apparatus 120 can generate the three-dimensional model using the method described in Moezzi. The volume intersection method is a specific example of the method of generating the three-dimensional model. Furthermore, the camera group 110 may capture images of a plurality of subjects 111. In this case, the model generation apparatus 120 can generate a plurality of three-dimensional models. Here, the plurality of three-dimensional models may correspond to different subjects 111, respectively. On the other hand, a three-dimensional model generation unit 121 may generate a three-dimensional model of a subject without using captured images. For example, the three-dimensional model generation unit 121 can generate a three-dimensional model in accordance with a user input. In this case, for example, a CAD or CG tool can be used.

The model generation apparatus 120 may generate information indicating a three-dimensional shape of a subject that changes chronologically. For example, the model generation apparatus 120 can generate a sequence of three-dimensional models indicating the three-dimensional shapes of the subject at respective times. By bringing the cameras 110 into synchronization with one another, the model generation apparatus 120 can generate chronological three-dimensional models from moving images captured by the camera group 110. In the present specification, a sequence denotes a collection of one or more three-dimensional models.

The image generation apparatus 100 includes an information input unit 130, a sequence selection unit 131, a time designation unit 132, a parameter designation unit 133, a model recording unit 134, a model obtainment unit 135, an image generation unit 136, and an output unit 137.

The information input unit 130 obtains information necessary for the generation of virtual viewpoint images. The information input unit 130 is, for example, an input apparatus, such as a keyboard and a pointing device. The information input unit 130 may include a monitor for displaying information. A user can input information using the information input unit 130. For example, in order to access the image generation apparatus 100, the user can input user information that specifies the user with use of the information input unit 130. Also, the user can input information that designates three-dimensional models (e.g., a sequence) used to generate virtual viewpoint images with use of the information input unit 130. Furthermore, the user can designate virtual viewpoints of virtual viewpoint images with use of the information input unit 130. For example, the user can input information that designates the times, locations, or orientations of virtual viewpoints.

The information input unit 130 obtains information that designates three-dimensional models in the foregoing manner, and outputs the information to the sequence selection unit 131. The information input unit 130 also obtains information that indicates virtual viewpoints in the foregoing manner, and outputs the information to the time designation unit 132 and the parameter designation unit 133. The information input unit 130 further obtains user information in the foregoing manner, and outputs the user information to a user information obtainment unit 141.

The sequence selection unit 131 selects a three-dimensional model in accordance with information obtained from the information input unit 130. In the present example, the sequence selection unit 131 selects a sequence of three-dimensional models. The sequence of three-dimensional models is stored in the model recording unit 134, which will be described later. The image generation unit 136, which will be described later, generates virtual viewpoint images using the sequence of three-dimensional models selected by the sequence selection unit 131.

The time designation unit 132 designates a frame in the sequence of three-dimensional models in accordance with information obtained from the information input unit 130. The image generation unit 136, which will be described later, generates a virtual viewpoint image using the three-dimensional model corresponding to the frame of the designated time among the sequence of three-dimensional models selected by the sequence selection unit 131. Note that in the present embodiment, this time may be referred to as the time of a virtual viewpoint. That is to say, a virtual viewpoint image from a virtual viewpoint of a specific time is generated using a three-dimensional model corresponding to this specific time.

The parameter designation unit 133 sets a virtual viewpoint parameter in accordance with information obtained from the information input unit 130. The type of the virtual viewpoint parameter is not limited in particular. The virtual viewpoint parameter may include at least one of the location and the orientation of a virtual viewpoint. Also, the virtual viewpoint parameter can be at least one of an external parameter and an internal parameter of a virtual camera corresponding to a virtual viewpoint. For example, the virtual viewpoint parameter may be the location, orientation, and focal length of a virtual viewpoint. Meanwhile, the virtual viewpoint parameter may be the location and focal length of a virtual viewpoint, and the location of a gaze point from the virtual viewpoint.

The model recording unit 134 stores data of three-dimensional models. The model recording unit 134 can store data of three-dimensional models generated by the model generation apparatus 120. It should be noted that the model recording unit 134 may store data of three-dimensional models generated by another apparatus. In the present embodiment, the model recording unit 134 stores three-dimensional models indicating the three-dimensional shapes of an object at respective times. With respect to one or more objects, the model recording unit 134 can store sequence data indicating three-dimensional models that respectively pertain to a plurality of times. For example, the model recording unit 134 can store data of three-dimensional models input from the three-dimensional model generation unit 121 on a per-sequence basis.

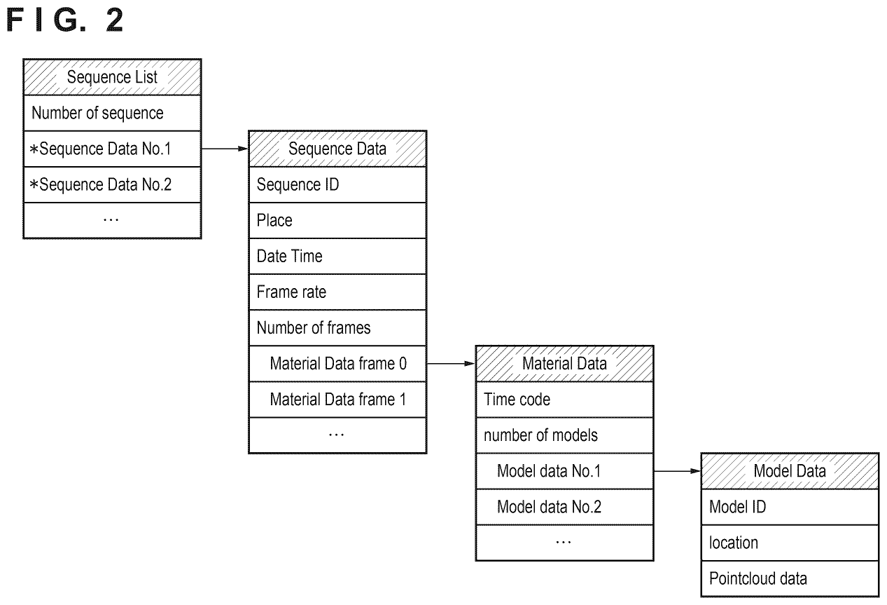

FIG. 2 shows an example of three-dimensional model data stored in the model recording unit 134. The model recording unit 134 stores a list of sequences stored in the model recording unit 134 (Sequence List). In this list, the number of sequences stored in the model recording unit 134 (number of sequence) is recorded. This number of sequences is increased by one each time a new sequence is registered. Also, in this list, information on a pointer to data of each sequence (*Sequence Data) is recorded. Data of a sequence (Sequence Data) can be accessed by referring to a pointer.

A sequence ID that specifies a sequence (Sequence ID), a place that is a place of shooting, a place of data generation, or the like (Place), and the date and time of shooting or data generation (Date Time) are recorded in data of the sequence (Sequence Data). In the present example, data of three-dimensional models is managed on a per-frame basis. One sequence is composed of one or more frames. The date and time (Date Time) indicate the date and time related to the first frame. Also, a frame rate (Frame rate) is recorded in data of a sequence. The date and time related to each frame can be calculated in accordance with the frame rate. The number of frames (Number of frames) is further recorded in data of a sequence. Furthermore, data of a sequence includes data related to each frame (Material Data).

Three-dimensional models of a plurality of objects may exist in each frame. For this reason, the number of three-dimensional models (number of models) is recorded in data of a frame (Material Data). Also, a time code indicating the time of a frame (Time code) is recorded in data of the frame (Material Data). Furthermore, data of a frame includes each piece of three-dimensional model data (Model Data).

A model ID for identifying a model (Model ID) is recorded in three-dimensional model data (Model Data). Also, three-dimensional model data includes a location of a three-dimensional model (location) and data of a point cloud representing the three-dimensional model (Point cloud data).

The sequence selection unit 131 can select a sequence stored in the model recording unit 134 in accordance with information on the sequence input from the information input unit 130. For example, the sequence selection unit 131 can specify a sequence ID by conducting a search based on information of the date and time or place. Then, the sequence selection unit 131 can select the sequence corresponding to the sequence ID.

Also, the time designation unit 132 can receive the time of a virtual viewpoint or a frame number from the information input unit 130. The time designation unit 132 can specify a desired frame from a sequence in accordance with the date and time and the frame rate included in data of the sequence.

The model obtainment unit 135 obtains, from the model recording unit 134, three-dimensional models of one or more objects at the designated time. In the present embodiment, the model obtainment unit 135 reads out, from the model recording unit 134, data of three-dimensional models corresponding to the frame designated by the time designation unit 132 out of the sequence selected by the sequence selection unit 131. Then, the model obtainment unit 135 inputs data of the three-dimensional models that have been read out to the image generation unit 136

Using the three-dimensional models of one or more objects at the designated time, the image generation unit 136 generates a virtual viewpoint image corresponding to the designated time from a virtual viewpoint based on the designated virtual viewpoint parameter. In the present embodiment, the image generation unit 136 generates the virtual viewpoint image in accordance with data of the three-dimensional models obtained from the model obtainment unit 135 and the virtual viewpoint parameter input from the parameter designation unit 133. A method of generating the virtual viewpoint image is not limited in particular. For example, the image generation unit 136 can generate the virtual viewpoint image in accordance with the ray tracing method.

The output unit 137 outputs the virtual viewpoint image generated by the image generation unit 136. The output unit 137 can transmit the virtual viewpoint image to a non-illustrated user apparatus, such as a tablet, a computer, and a display device. The display device may be a display included in the information input unit 130.

Next, the information processing apparatus 101 according to an embodiment will be described. The information processing apparatus 101 includes a user information obtainment unit 141, a determination unit 142, and an information recording unit 143.

The user information obtainment unit 141 obtains information of a user who has issued an instruction for generating a virtual viewpoint image. The user information obtainment unit 141 is connected to the information input unit 130, and can obtain information of a user who is accessing the image generation apparatus 100. Information of the user is information with which the user can be specified, and is a name or a user ID, for example.

The determination unit 142 determines whether a predetermined condition, which is a condition related to at least one of time and the virtual viewpoint parameter, is satisfied. As described above, the image generation unit 136 generates a virtual viewpoint image corresponding to the designated time from a virtual viewpoint based on the designated virtual viewpoint parameter. The predetermined condition is a condition related to these designated time and designated virtual viewpoint parameter. The determination unit 142 can obtain information indicating the selected sequence, time information, and the virtual viewpoint parameter from the sequence selection unit 131, time designation unit 132, and parameter designation unit 133 for this determination.

For example, the determination unit 142 can determine whether the predetermined condition is satisfied based on a relationship between the times that are respectively related to two or more virtual viewpoint images generated by the image generation unit 136. Specifically, the determination unit 142 can determine that the predetermined condition is satisfied in a case where many virtual viewpoint images related to adjacent times have been generated. This is because it is relatively easy to generate three-dimensional models using many virtual viewpoint images related to adjacent times. Note that the predetermined condition may be a condition related to a relationship between the times that are respectively related to two or more virtual viewpoint images generated by the image generation unit 136 using the same sequence data. Also, the predetermined condition may be a condition related to a relationship between the times that are respectively related to two or more virtual viewpoint images generated by the image generation unit 136 using the chronological three-dimensional models pertaining to the same object.

Furthermore, the determination unit 142 can determine whether the predetermined condition is satisfied based on a relationship between virtual viewpoint parameters that are respectively related to two or more virtual viewpoint images generated by the image generation unit 136. Specifically, the determination unit 142 can determine that the predetermined condition is satisfied in a case where many virtual viewpoint images related to adjacent sections inside a virtual space have been generated. This is because it is relatively easy to generate three-dimensional models using many virtual viewpoint images related to adjacent sections. Note that the predetermined condition may be a condition related to a relationship between virtual viewpoint parameters that are respectively related to two or more virtual viewpoint images generated by the image generation unit 136 using the same sequence data. Also, the predetermined condition may be a condition related to a relationship between virtual viewpoint parameters that are respectively related to two or more virtual viewpoint images generated by the image generation unit 136 using the chronological three-dimensional models pertaining to the same object.

In the following embodiment, the determination unit 142 determines whether the predetermined condition, which is a condition related to both of time and the virtual viewpoint parameter, is satisfied. For example, based on time information and virtual viewpoint parameters, the determination unit 142 can determine whether a plurality of virtual viewpoint images related to the same time or times within a predetermined, short time period have been generated from virtual viewpoints that satisfy a specific condition. The specific condition related to the virtual viewpoints may be, for example, the virtual viewpoints being arranged around the same object.

In response to satisfaction of the predetermined condition, the information recording unit 143 records information on the three-dimensional models of the object corresponding to the virtual viewpoint images generated by the image generation unit 136. The recorded information on the three-dimensional models can be information used in specification of the three-dimensional models. The information recorded by the information recording unit 143 is not limited in particular; any information that is helpful in specification of the three-dimensional models that have been used by the image generation unit 136 to generate virtual viewpoint images can be recorded. Note that a three-dimensional model need not be specifiable based only on information on this three-dimensional model. For example, a three-dimensional model may be specifiable based on information on this three-dimensional model and another type of information (e.g., a user input).

For example, the information recording unit 143 can record at least one of time and the virtual viewpoint parameter as information on a three-dimensional model of an object. Specifically, the information recording unit 143 can record information indicating the time of a virtual viewpoint corresponding to the generated virtual viewpoint image. As will be described later, sequence data and an object corresponding to a three-dimensional model that is an inspection target can be specified manually or automatically. Then, among the chronological three-dimensional models related to this object, a three-dimensional model corresponding to the recorded time of a virtual viewpoint can be specified as a three-dimensional model that is a comparison target.

Also, the information recording unit 143 can record information indicating a virtual viewpoint parameter corresponding to the generated virtual viewpoint image. As will be described later, sequence data corresponding to the three-dimensional model that is the inspection target can be specified manually or automatically. Then, among a plurality of objects indicated by this sequence data, an object inside a field of view based on the virtual viewpoint parameter can be specified as an object corresponding to the three-dimensional model that is the inspection target. Note that the selection of a three-dimensional model that is a comparison target from among the chronological three-dimensional models related to the specified object can be specified manually or automatically as will be described later.

Also, the information recording unit 143 can record information that specifies sequence data used to generate a virtual viewpoint image as information on a three-dimensional model of an object. For example, the information recording unit 143 can record a sequence ID of a sequence that has been used to generate a virtual viewpoint image. As will be described later, sequence data corresponding to the three-dimensional model that is the inspection target can be specified by referring to such information.

Furthermore, the information recording unit 143 can record user information of a user who has issued an instruction for generating a virtual viewpoint image. For example, the information recording unit 143 can record user information on a user who has issued an instruction for generating a virtual viewpoint image, which has been obtained by the user information obtainment unit 141. By referring to such information, a user who is suspected to have made a copy of a three-dimensional model of an object can be specified.

Note that in response to satisfaction of the predetermined condition, the information recording unit 143 can record log information indicating that a virtual viewpoint image has been generated. The information recording unit 143 can store the above-described information on a three-dimensional model of an object as a part of such log information. For example, the information recording unit 143 can record log information indicating that a virtual viewpoint image has been generated using a three-dimensional model of an object at the designated time.

Note that the information processing apparatus 101 is activated at the same time as activation of the image generation apparatus 100. Also, processing of the information processing apparatus 101 is ended at the same time as the end of processing of the image generation apparatus 100.

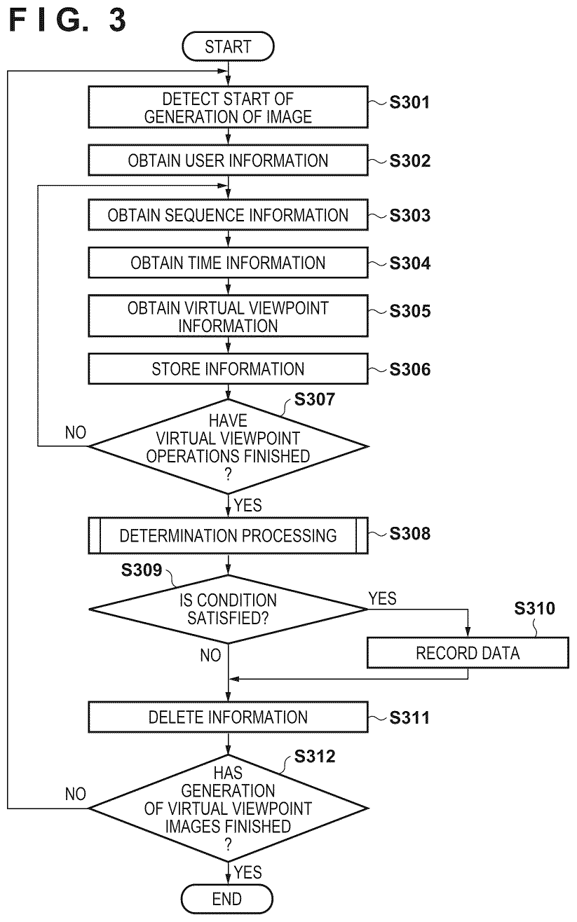

FIG. 3 is a flowchart showing an example of processing executed by the determination unit 142. In step S301, the determination unit 142 detects the start of generation of a virtual viewpoint image by the image generation apparatus 100. The determination unit 142 can detect the generation of the virtual viewpoint image based on inputting of user information. Note that the image generation apparatus 100 generates the virtual viewpoint image before step S302 or in parallel with steps S302 to S306. That is to say, before step S302 or in parallel with steps S302 to S306, the model obtainment unit 135 obtains three-dimensional models, the image generation unit 136 generates the virtual viewpoint image, and the output unit 137 outputs the virtual viewpoint image. The image generation unit 136 may generate the virtual viewpoint image in response to a user's operation on a virtual viewpoint via the information input unit 130. For example, the image generation unit 136 can generate the virtual viewpoint image in response to a change made to the time or virtual viewpoint parameter of the virtual viewpoint.

In step S302, the determination unit 142 obtains information of the user from the user information obtainment unit 141. In step S303, the determination unit 142 obtains, from the sequence selection unit 131, information of a selected sequence that is used to generate the virtual viewpoint image. In the present embodiment, the determination unit 142 obtains a sequence ID. However, the information of the sequence is not limited to the sequence ID. For example, the determination unit 142 may obtain a sequence name or a file name of data of the sequence as the information of the sequence. In step S304, the determination unit 142 obtains information of the time of a virtual viewpoint used to generate the virtual viewpoint image from the time designation unit 132. In step S305, the determination unit 142 obtains the virtual viewpoint parameter used to generate the virtual viewpoint image from the parameter designation unit 133. In this way, the determination unit 142 can obtain information that is used to determine whether the predetermined condition is satisfied, and information to be recorded in the information recording unit 143. The order of steps S301 to S305 may be different. Also, the determination unit 142 need not obtain all of these pieces of information.

In step S306, the determination unit 142 temporarily stores such information as the sequence ID, time information, and the virtual viewpoint parameter obtained in steps S302 to S305. In the present embodiment, the determination unit 142 stores these pieces of information into a memory inside the determination unit 142.

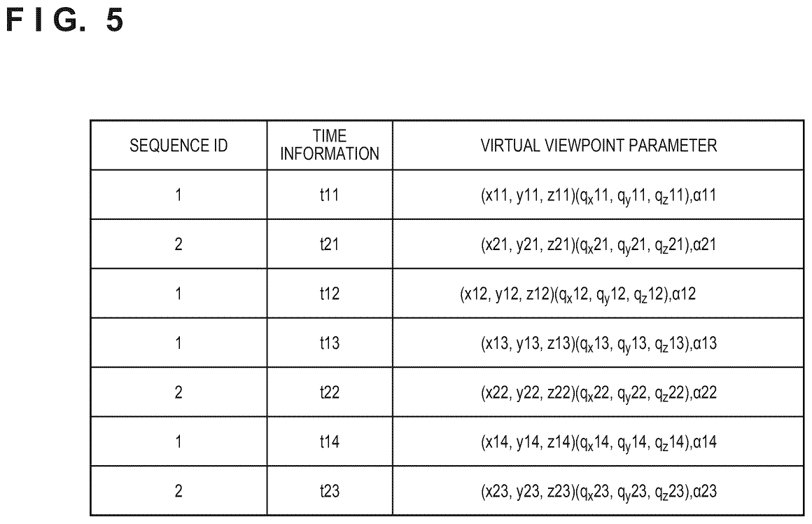

FIG. 5 shows an example of the information that the determination unit 142 has stored into the memory. In the example of FIG. 5, the location, orientation, and focal length of a virtual viewpoint are used as the virtual viewpoint parameter. The location of the virtual viewpoint is indicated by three values related to the x-, y-, and z-axes. The orientation of the virtual viewpoint can be represented by, for example, a quaternion indicated by (1).

Q=(0:qₓ,q_{y},qₓ) (1)

In formula (1), the left side of the colon represents a real part, whereas qₓ, q_{y}, and qₓ represent an imaginary part. The focal length can be represented by a zoom magnification. In the example of FIG. 5, the focal length is represented by α.

In step S307, the determination unit 142 determines whether a series of virtual viewpoint operations has finished. The determination unit 142 can determine that the virtual viewpoint operations have finished in a case where a series of inputs from the information input unit 130 has finished. In this case, processing proceeds to step S308. In a case where there is a subsequent input, processing returns to step S303. Then, the determination unit 142 continuously obtains information for generating the next virtual viewpoint image.

In step S308, the determination unit 142 determines whether the predetermined condition, which is a condition related to at least one of time and the virtual viewpoint parameter, is satisfied. The determination unit 142 executes this determination processing on a per-sequence basis.

In the present example, the predetermined condition includes a condition related to an interval between the times related to two virtual viewpoint images. Specifically, the predetermined condition is a condition related to the number D of specific pairs of virtual viewpoint images among the plurality of virtual viewpoint images generated by the image generation unit 136. Here, for each specific pair of virtual viewpoint images, the interval between the times is smaller than a threshold ThT. In the following example, the determination unit 142 determines whether such a time-related condition is satisfied in step S405.

Furthermore, in the present example, the predetermined condition includes a condition related to the positional relationship between virtual viewpoints that respectively pertain to two or more virtual viewpoint images generated by the image generation unit 136. Specifically, the predetermined condition includes a condition related to similarity between gaze points, or areas within fields of view, of virtual viewpoints that respectively pertain to two or more virtual viewpoint images generated by the image generation unit 136. In the following example, the determination unit 142 determines whether such a condition related to the positional relationship between virtual viewpoints is satisfied in step S407.

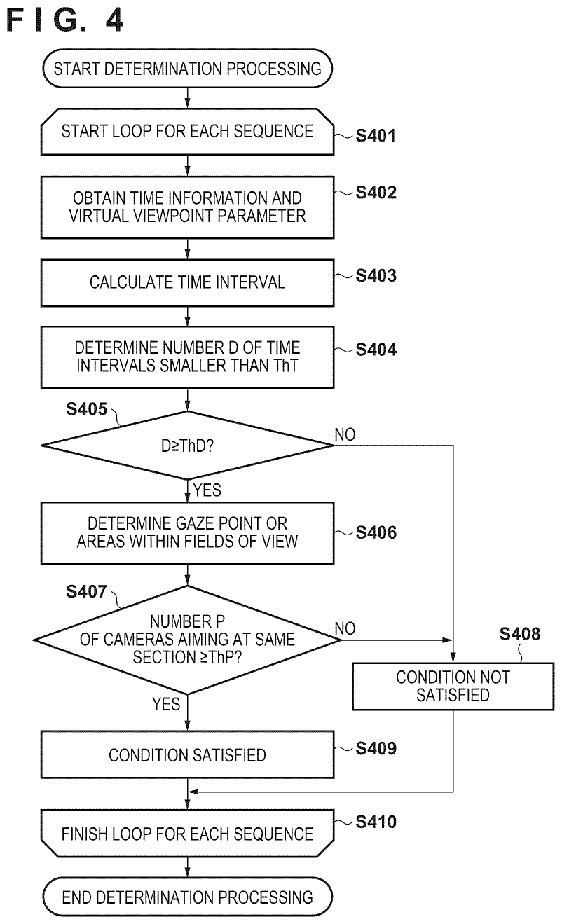

FIG. 4 is a detailed flowchart of an example of the determination processing in step S308. In step S401, a loop for each sequence is started. For all of the sequences corresponding to the sequence IDs stored in step S306, the determination processing is executed on a per-sequence basis. In step S401, the determination unit 142 sets a sequence targeted for the determination processing in order.

In step S402, the determination unit 142 obtains, from the memory, every set of the time and the virtual viewpoint parameter related to the sequence set in step S401. In the example of FIG. 5, in a case where the sequence with the sequence ID=1 is set as a target of the determination processing, the determination unit 142 obtains four sets of the time and the virtual viewpoint parameter.

In step S403, the determination unit 142 calculates a time interval with respect to every combination of times. In the example of FIG. 5, in a case where the target of the determination processing is the sequence with the sequence ID=1, the determination unit 142 can calculate the following six intervals.

$$Δ t 12 = \vert t 11 - t 12 \vert$$

$$Δ t 13 = \vert t 11 - t 13 \vert$$

$$Δ t 14 = \vert t 11 - t 14 \vert$$

$$Δ t 23 = \vert t 12 - t 13 \vert$$

$$Δ t 24 = \vert t 12 - t 14 \vert$$

$$Δ t 34 = \vert t 13 - t 14 \vert$$

In step S404, the determination unit 142 determines the number D of intervals smaller than the threshold ThT among the calculated intervals Δt12 to Δt34. For example, the threshold ThT may be the interval between the first frame and the second frame, or the interval between the first frame and the third frame, in accordance with the frame rate. Furthermore, the threshold ThT may be changed dynamically in accordance with a moving speed of an object. For example, in a case where the moving speed of the object is the lower, the threshold ThT can be increased. For example, in a case where the moving speed of the object is the higher, the threshold ThT may be 1/30 seconds. Also, in a case where the moving speed of the object is the lower, the threshold ThT may be 1/10 seconds.

In step S405, the determination unit 142 determines whether the value D calculated in step S404 is equal to or larger than a threshold ThD. If the value D is equal to or larger than the threshold ThD, processing proceeds to step S406; otherwise, processing proceeds to step S408. Note that the condition related to time intervals is not limited to the foregoing, that is to say, the value D being equal to or larger than the threshold ThD. For example, the predetermined condition may be a condition related to the number of virtual viewpoint images corresponding to times included in a predetermined time range among the plurality of virtual viewpoint images generated by the image generation unit 136. For example, the determination unit 142 may determine that the predetermined condition is satisfied in a case where the times related to three or more virtual viewpoint images among the plurality of virtual viewpoint images generated using the sequence set in step S401 are included in the predetermined time range (e.g., in two frames). Note that the predetermined condition may be set so that it is not satisfied in a case where normal, chronological playback is performed while moving between virtual viewpoints. For example, in a case where the threshold ThT is the interval between the first frame and the second frame based on the frame rate, the threshold ThD can be set at three or more.

In step S406, with respect to the set of the virtual viewpoint images generated using the sequence set in step S401, the determination unit 142 determines gaze points or areas within fields of view of the virtual viewpoints. The gaze points or the areas within fields of view of the virtual viewpoints can be determined in accordance with the virtual viewpoint parameter of each virtual viewpoint image stored in step S306. Note that in a case where three-dimensional models are arranged on a field, a gaze point can be represented as an intersection between the center of the line of sight of a virtual viewpoint and the field. Also, an area within a field of view can be represented as an area of a field within a field of view of a virtual viewpoint.

In step S407, with respect to the set of virtual viewpoint images generated using the sequence set in step S401, the determination unit 142 determines whether their respective virtual viewpoints are pointed at the same section. The determination unit 142 can determine the number P of virtual viewpoints that are pointed at the same section in this way. For example, in a case where the distance between gaze points is equal to or shorter than a threshold, or in a case where the area of an overlap between areas within fields of view is equal to or larger than a threshold, the determination unit 142 can determine that each virtual viewpoint is pointed at the same section. As another example, in a case where the virtual viewpoints are arranged at an equal interval on a substantial circumference or on a substantial spherical surface centered at a gaze point, or in a case where the virtual viewpoints are spaced with a substantially equal interval, the determination unit 142 can determine that each virtual viewpoint is pointed at the same section. If the number P of virtual viewpoints that are pointed at the same section is equal to or larger than a threshold ThP, processing proceeds to step S409; otherwise, processing proceeds to step S408.

In step S408, the determination unit 142 determines that the predetermined condition is not satisfied with respect to the sequence set in step S401.

In step S409, the determination unit 142 determines that the predetermined condition is satisfied with respect to the sequence set in step S401.

In step S410, the determination unit 142 determines whether the determination processing has been executed with respect to every sequence. In a case where the determination processing has not been executed with respect to every sequence, processing returns to step S401, and the determination unit 142 sets the next sequence as a target of the determination processing.

The determination processing in step S308 is executed in the above-described manner. In step S309, the determination unit 142 determines whether there is a sequence that has been determined to satisfy the predetermined condition. In a case where there is a sequence that satisfies the predetermined condition, processing proceeds to step S310; otherwise, processing proceeds to step S311.

In step S310, with respect to the virtual viewpoint images generated using the sequence that has been determined to satisfy the predetermined condition, the determination unit 142 outputs information on the three-dimensional models of an object corresponding to such virtual viewpoint images for the purpose of recording by the information recording unit 143. In a case where it has been determined that the predetermined condition is satisfied with respect to the sequence set in step S401 (e.g., the sequence ID=1), the determination unit 142 can record information related to each of the four virtual viewpoint images (time=t11 to t14) into the information recording unit 143.

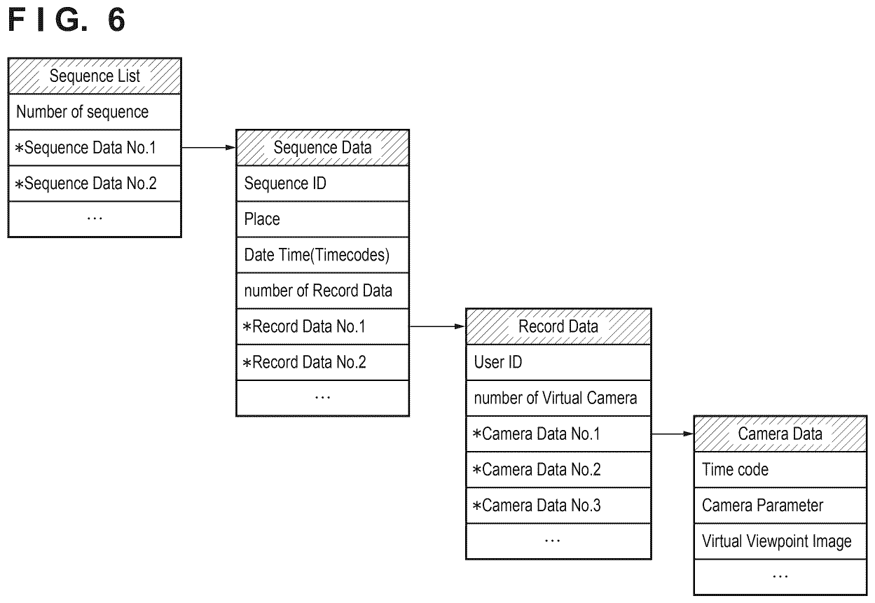

In the following example, information on a three-dimensional model of an object corresponding to a virtual viewpoint image is information that has been used to generate the virtual viewpoint image. For example, the determination unit 142 can record a set of a sequence ID, the time of a virtual viewpoint, a virtual viewpoint parameter, and user information into the information recording unit 143. FIG. 6 shows an example of data recorded in the information recording unit 143.

The information recording unit 143 stores a list of recorded sequences (Sequence List). In this list, the number of recorded sequences (number of sequence) is recorded. Also, in this list, a pointer to data related to each recorded sequence (*Sequence Data) is recorded.

A sequence ID that specifies a sequence (Sequence ID) is recorded in data related to the sequence (Sequence Data). Also, although not essential, a place of shooting of an object representing a sequence or a place of generation of the sequence (Place), and the date and time or time code of shooting or generation (Date Time (Timecode)), can be recorded in data related to the sequence. The number of recorded records (number of Record Data) is further recorded in data related to the sequence. Furthermore, a pointer to each piece of record data (*Record data) is recorded in data related to the sequence.

With respect to a sequence that has been determined to satisfy the predetermined condition in step S308, record data (Record Data) stores information that has been used to generate virtual viewpoint images using this sequence. In the example of FIG. 6, user information obtained by the user information obtainment unit 141, which is a user ID (User ID) in the present example, is recorded in record data. Also, the number of pieces of information of virtual viewpoints (number of Virtual Camera), and a pointer to data of each virtual viewpoint (*Camera Data), are recorded in record data.

The time of a virtual viewpoint, which is a time code (Time code) in the present example, and a virtual viewpoint parameter (Camera Parameter) are recorded in data of each virtual viewpoint (Camera Data). The time and the virtual viewpoint parameter of the virtual viewpoint are the same as the information shown in FIG. 5. Note that in FIG. 6, data itself may be recorded in place of a pointer to each piece of data.

In step S310, the determination unit 142 updates or makes an addition to data recorded in the information recording unit 143. For example, in a case where the sequence ID of a sequence to be newly recorded is not included in the list of sequences, the determination unit 142 adds one to the number of sequences. Also, the determination unit 142 secures a memory for recording data of the sequence (Sequence Data), and adds a pointer to this data (*Sequence Data).

The sequence ID is recorded in the sequence data indicated by this pointer. Also, the determination unit 142 may record information on the sequence obtained from the model recording unit 134 (e.g., the place or the date and time) into the information recording unit 143. Furthermore, the determination unit 142 sets one as the number of recorded records in the sequence data (number of Record Data). Then, the determination unit 142 secures a memory for recording the record data, and adds a pointer to this data (*Record Data No. 1).

The user ID, which is user information, is recorded in the record data indicated by this pointer. Also, the determination unit 142 records the number of pieces of information of virtual viewpoints (number of Virtual Camera). The time of a virtual viewpoint, such as a time code (Time code), and a virtual viewpoint parameter (Camera Parameter) can be recorded in information of each virtual viewpoint.

Furthermore, for example, in a case where the sequence ID of a sequence to be newly recorded is included in the list of sequences, the determination unit 142 updates sequence data related to this sequence. For example, the determination unit 142 adds one to the number of recorded records in the sequence data (number of Record Data). Also, the determination unit 142 secures a memory for recording data of the sequence (Sequence Data), and adds a pointer to this data (*Sequence Data). Information recorded in the record data indicated by this pointer is similar to that of the case where the sequence ID of the sequence to be newly recorded is not included in the list of sequences.

In step S311, the determination unit 142 deletes information that has been temporarily stored in the memory of the determination unit 142. For example, the determination unit 142 deletes such data as the sequence IDs, times, and virtual viewpoint parameters that are referred to in the determination processing.

In step S312, the determination unit 142 determines whether the generation of all virtual viewpoint images has finished. In a case where the generation of a virtual viewpoint image is to be continued, processing returns to step S301. Otherwise, processing of FIG. 3 is ended.

In the foregoing example, the determination of whether the predetermined condition is satisfied in step S308 is made on a per-sequence basis. However, the determination of whether the predetermined condition is satisfied may be made for each virtual viewpoint image. For example, in step S308, the determination unit 142 can determine whether a condition related to at least one of the time and the virtual viewpoint parameter of a virtual viewpoint image of interest is satisfied. Specifically, the determination unit 142 can calculate the intervals (Δt12 to Δt14) between the time of the virtual viewpoint image of interest (e.g., t11) and the times of other virtual viewpoint images that have been generated using the same sequence (e.g., t12 to t14). Then, the determination unit 142 can determine the number D of intervals smaller than the threshold ThT among the calculated intervals (Δt12 to Δt14). The determination unit 142 can determine that the time related to the virtual viewpoint image of interest satisfies the predetermined condition in a case where this value D is equal to or larger than the threshold ThD.

Similarly, the determination unit 142 can determine whether the virtual viewpoint related to the virtual viewpoint image of interest is pointed at the same section as the virtual viewpoint related to any of other virtual viewpoint images that have been generated using the same sequence. The determination unit 142 can determine that the virtual viewpoint parameter related to the virtual viewpoint image of interest satisfies the predetermined condition in a case where these virtual viewpoints are pointed at the same section. The determination unit 142 can determine that the predetermined condition related to the virtual viewpoint image of interest is satisfied in response to the determination that both of the time and the virtual viewpoint parameter related to the virtual viewpoint image of interest satisfy the predetermined condition. In this case, in step S310, information on a three-dimensional model of an object corresponding to the virtual viewpoint image of interest can be recorded into the information recording unit 143.

With the above-described configuration, information on a three-dimensional model of an object corresponding to a virtual viewpoint image can be stored in a case where the predetermined condition is satisfied. In general, a recording apparatus with an extremely large capacity is required to record such information with respect to all of the virtual viewpoint images that have been generated. By storing such information only in a case where the predetermined condition is satisfied as in the present embodiment, the amount of stored information can be reduced. On the other hand, according to the present embodiment, the predetermined condition can be set so that it is satisfied in a case where a virtual viewpoint image has been generated for the purpose of making a copy of a three-dimensional model, or in a case where a virtual viewpoint image has been generated that allows a copy of a three-dimensional model to be easily made. Therefore, according to the present embodiment, whether a copy of a three-dimensional model has been made based on a virtual viewpoint image can be verified effectively without recording information related to a three-dimensional model of an object corresponding to a virtual viewpoint image with respect to every virtual viewpoint image that has been generated. Furthermore, reducing the amount of stored information in this way makes it possible to reducing the load on processing for determining whether a copy of a three-dimensional model has been made based on a virtual viewpoint image with reference to stored information.

Note that a plurality of users may simultaneously generate virtual viewpoint images using the image generation apparatus 100. In this case, it is possible to obtain and store information on the generation of virtual viewpoint images, make the determination about the predetermined condition, and record information based on the determination result on a per-user basis. Furthermore, in this case, the information recording unit 143 may be accessed using a time-division method or in the order of accesses made by the users.

Also, it is assumed that virtual viewpoint images may be generated at a plurality of separate timings, rather than at one timing, to make a copy of three-dimensional data. For this reason, instead of executing the determination processing in step S308 after the series of virtual viewpoint operations has finished as in step S307, processing of steps S308 to S311 may be executed after the generation of all virtual viewpoints has finished as in step S312. Furthermore, information on the generation of virtual viewpoint images using the image generation apparatus 100 may be stored for a certain time period. In this case, the determination unit 142 may determine whether the predetermined condition is satisfied with reference to the stored information. Specifically, the determination unit 142 may determine whether the predetermined condition is satisfied based on the interval between the time of a virtual viewpoint when a virtual viewpoint image was generated in the past and the time of the virtual viewpoint when a virtual viewpoint image was generated presently. In addition, the determination unit 142 may determine whether the predetermined condition is satisfied based on a commonality between the section at which a virtual viewpoint was pointed when a virtual viewpoint image was generated in the past and the section at which the virtual viewpoint was pointed when a virtual viewpoint image was generated presently. For example, the memory of the determination unit 142 can hold information that has been stored for a certain time period. Then, in a case where a virtual viewpoint image is generated by the same user, the determination unit 142 can read out the sequence ID, time, and virtual viewpoint parameter corresponding to the same user ID from the memory. Then, the determination unit 142 can execute the determination processing based on the information that has been read out. A specific length of the certain time period is not limited in particular. For example, this certain time period may be a time period in which three-dimensional model data is accessible, or a predetermined time period that has been set.

In the above-described embodiment, information of a user him/herself (e.g., a user ID) is used as user information. However, the type of user information is not limited in particular. For example, the user may own an information processing apparatus that is connected to the image generation apparatus 100 via a network or the like. In this case, the user can obtain a generated virtual viewpoint image by controlling the image generation apparatus 100 via the information processing apparatus owned by the user. In such an example, the user information may be identification information (e.g., a serial number) of the information processing apparatus owned by the user. Such user information may be recorded in the information processing apparatus 101.

### Modification Example

The determination unit 142 may further store at least a part of the virtual viewpoint images generated by the image generation unit 136 in addition to the information used in the generation of the virtual viewpoint images. In such a modification example, the determination unit 142 reads out, from the image generation unit 136, the virtual viewpoint images that have been generated using a sequence that has been determined to satisfy the predetermined condition in step S310. Then, the determination unit 142 outputs at least a part of the virtual viewpoint images that have been read out for the purpose of storage in an image storage unit 144. The image storage unit 144 stores at least a part of the virtual viewpoint images output from the determination unit 142.

In such a modification example, as shown in FIG. 6, data of a virtual viewpoint (Camera Data) recorded in the information recording unit 143 includes a virtual viewpoint image (Virtual View Point Image) in addition to the time code (Time code) and the virtual viewpoint parameter (Camera Parameter). This virtual viewpoint image is a virtual viewpoint image that has been generated by the image generation unit 136 in accordance with the time code and the virtual viewpoint parameter. In this way, in addition to information on the generation of virtual viewpoint images that satisfy the predetermined condition, the virtual viewpoint images that have been generated in accordance with this information can be stored. Storing virtual viewpoint images makes it possible to facilitate the search for a corresponding three-dimensional model or a corresponding time code recorded in the model recording unit 134 when estimating whether a copy of the three-dimensional model has been made based on the virtual viewpoint images.

Note that the image storage unit 144 may be embedded in the information recording unit 143. That is to say, the information recording unit 143 may store virtual viewpoint images.

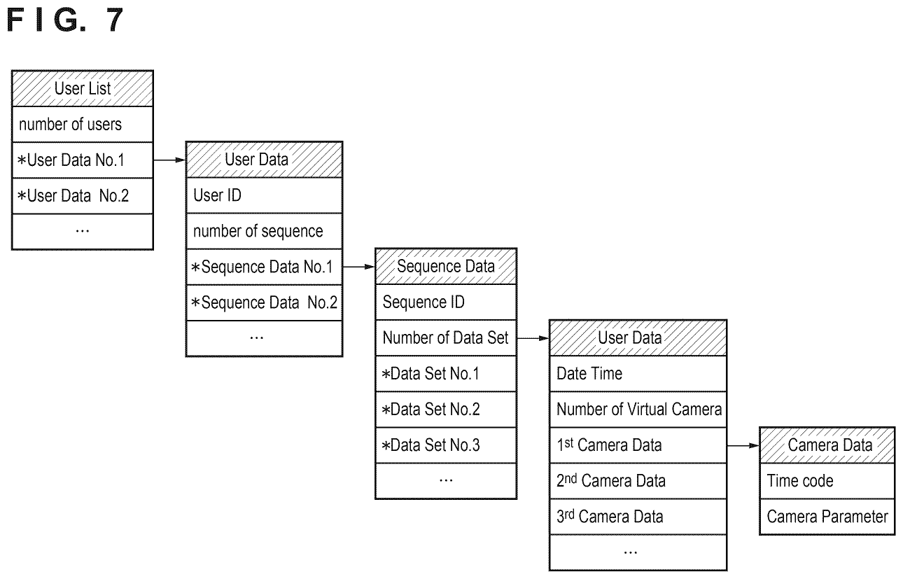

Furthermore, data may be recorded in the information recording unit 143 on a per-user basis. FIG. 7 shows an example of data recorded on a per-user basis. The information recording unit 143 stores a list of users (User List). In this list, the number of users (number of user) is recorded. In this list, only the users who have performed an operation of generating the virtual viewpoint images that have been determined to satisfy the predetermined condition by the determination unit 142 may be recorded. Also, in this list, pointers to pieces of data of the respective users (*User Data) are recorded.

Information that specifies a user, such as a user ID (User ID), is recorded in data of each user (User Data). Furthermore, a pointer to data of a sequence (*Sequence Data) that has been used by a user in generating virtual viewpoint images based on the virtual viewpoint parameters that satisfy the predetermined condition, and the number of pieces of data in the sequence (number of sequence), are recorded in data of each user.

A sequence ID that specifies a sequence (Sequence ID) is recorded in data related to the sequence (Sequence Data). Also, pointers to data sets (*Data Set) including time information and virtual viewpoint parameters of the time when the predetermined condition was satisfied in generation of virtual viewpoint images using a sequence are recorded in data related to this sequence. Furthermore, the number of recorded data sets (Number of Data Set) is recorded in data related to a sequence.

Time information (Date Time) of the time when the predetermined condition was satisfied, and the number of pieces of information of recorded virtual viewpoints (number of Virtual Camera), are recorded in each data set. Time information, such as a time code (Time code), and a virtual viewpoint parameter (Camera Parameter) are recorded in information of each virtual viewpoint.

In the foregoing example, in a case where a specific condition is satisfied, such information as a sequence used in generation of virtual viewpoint images, times, and virtual viewpoint parameters are recorded in the information recording unit 143 for each user who has performed an operation using the information input unit 130. By thus managing the records on a per-user basis, the time period required to verify whether a copy of a three-dimensional model has been made can be reduced in a case where a user who has made the copy of the three-dimensional model can be estimated.

### (Verification of Copy)

As described above, the information processing apparatus 101 can store information on generation of virtual viewpoint images. By referring to the information that has been thus stored, whether a three-dimensional shape created by a third party is a copy that has been made based on virtual viewpoint images of the image generation apparatus 100 can be estimated. This determination may be made visually by the user, or may be made automatically or semi-automatically in accordance with a user input.

The following describes an information processing system that performs such estimation. An information processing system according to an embodiment includes an information processing apparatus 200. The information processing apparatus 200 compares a three-dimensional model that is an inspection target with a three-dimensional model that has been used to generate a virtual viewpoint image in the past. The information processing apparatus 200 can access data included in the model recording unit 134 of the image generation apparatus 100. Then, the information processing apparatus 200 can estimate whether an inspection target 211 created by a third party is a copy that has been made using a three-dimensional model stored in the model recording unit 134.

The information processing apparatus 200 includes a data obtainment unit 210, a data analysis unit 212, and a result output unit 213. The data obtainment unit 210 obtains a three-dimensional model that is an inspection target. For example, the data obtainment unit 210 can obtain three-dimensional model data of the inspection target 211. A method of obtaining three-dimensional model data is not limited in particular. For example, using the camera group 110, the model generation apparatus 120 may generate a three-dimensional model that is the inspection target 211. At this time, the data obtainment unit 210 can obtain the three-dimensional model that is the inspection target 211 from the model generation apparatus 120. Also, three-dimensional model data may be generated using a measurement apparatus, such as a 3D scanner. For example, a 3D scanner based on a contact method, a laser beam method, or a pattern light projection method can be used. Furthermore, the format of three-dimensional model data is not limited in particular. For example, three-dimensional model data may be three-dimensional point cloud data indicating a shape.

The data analysis unit 212 obtains, from the model recording unit 134 that stores three-dimensional models indicating the three-dimensional shapes of objects, a three-dimensional model that has been used to generate a virtual viewpoint image in the past as a three-dimensional model that is a comparison target. Specifically, the data analysis unit 212 can search for a three-dimensional model which corresponds to the three-dimensional model data of the inspection target 211 and which is stored in the model recording unit 134. Here, the data analysis unit 212 can obtain the three-dimensional model that is the comparison target with reference to a record of generation of virtual viewpoint images. For example, the data analysis unit 212 can search for a three-dimensional model stored in the model recording unit 134 based on information recorded in the information recording unit 143. As stated earlier, the information recording unit 143 can record at least one of the time and the virtual viewpoint parameter corresponding to a virtual viewpoint image as a record of generation of the virtual viewpoint image. In this embodiment, the data analysis unit 212 can obtain the three-dimensional model that has been used to generate the virtual viewpoint image with reference to at least one of the time and the virtual viewpoint parameter corresponding to the virtual viewpoint image.

For example, the data analysis unit 212 specifies, among the sequences recorded in the model recording unit 134, a sequence that has been used to generate a virtual viewpoint image that is assumed to have been used to generate the inspection target 211. The data analysis unit 212 may automatically specify the sequence corresponding to the inspection target 211 based on the shape of the three-dimensional model that is the inspection target 211, or on the texture thereof, such as a uniform and a player name. On the other hand, the data analysis unit 212 may obtain a user input indicating the sequence corresponding to the inspection target 211 from the user.

Also, with respect to the sequence thus specified, the data analysis unit 212 specifies a time code of the three-dimensional model that has been used to generate the virtual viewpoint image that is assumed to have been used to generate the inspection target 211. For example, the user may set a time code corresponding to the inspection target 211. In this case, the user can select a time code corresponding to the inspection target 211 from among the time codes recorded in the information recording unit 143 that pertain to the specified sequence. For example, the user can select the time code so that the three-dimensional model related to the time code selected by the user resembles the inspection target 211. Then, the data analysis unit 212 can read out the three-dimensional model corresponding to the set time code from the model recording unit 134. The model recording unit 134 stores data of three-dimensional models that have been input from the three-dimensional model generation unit 121 and stored on a per-sequence basis.

Furthermore, with respect to the sequence thus specified, the data analysis unit 212 specifies a three-dimensional model that has been used to generate the virtual viewpoint image that is assumed to have been used to generate the inspection target 211. For example, the data analysis unit 212 can specify a three-dimensional model that is a comparison target corresponding to the three-dimensional model that is the inspection target among the three-dimensional models of a plurality of objects related to the specified sequence. Here, the data analysis unit 212 can specify a three-dimensional model that is within a field of view based on the virtual viewpoint parameter at the specified time code as the three-dimensional model that is the comparison target. On the other hand, the user may specify the three-dimensional model that is the comparison target corresponding to the inspection target 211.

Then, the data analysis unit 212 compares the three-dimensional model that is the inspection target with the three-dimensional model that is the comparison target. Specifically, the data analysis unit 212 can analyze and make a comparison between the three-dimensional model that is the inspection target 211 and the three-dimensional model that is the comparison target, which is stored in the model recording unit 134. The result output unit 213 outputs the result of analysis and comparison performed by the data analysis unit 212.

Furthermore, the data analysis unit 212 verifies similarity between the three-dimensional model that is the inspection target 211, which has been obtained by the data obtainment unit 210, and the three-dimensional model that has been read out from the model recording unit 134. In a case where it has been determined that there is similarity, the result output unit 213 can output the estimation result indicating that the inspection target 211 is a copy of a three-dimensional model stored in the model recording unit 134. At this time, the result output unit 213 can output user information (e.g., a user ID) related to a user who has generated a virtual viewpoint image using the three-dimensional model that has been read out from the model recording unit 134. Also, the result output unit 213 may output time information (a time code) related to this three-dimensional model. These pieces of information are recorded in the information recording unit 143. A method of outputting information from the result output unit 213 is not limited in particular. For example, the result output unit 213 can provide a notification indicating that it has been determined that there is similarity as a display or a sound. Furthermore, the result output unit 213 can output the determination result also in a case where it has not been determined that there is similarity.

The result output unit 213 can store these pieces of information in addition to or instead of outputting them. For example, the result output unit 213 can store the user ID and the time information. Also, the result output unit 213 may further store, for example, the three-dimensional model data of the inspection target 211. In addition, the output from the result output unit 213 may be recorded in the information recording unit 143.

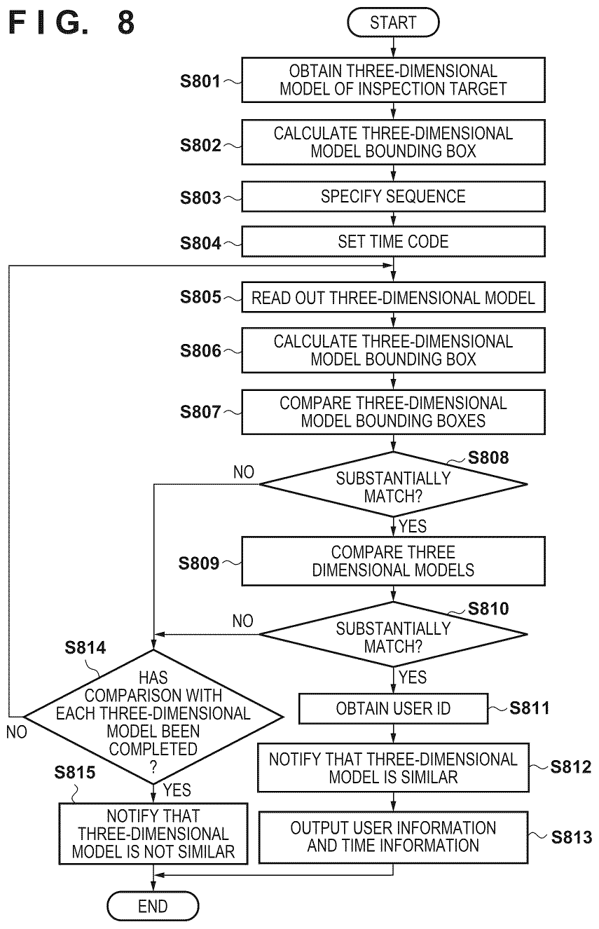

FIG. 8 is a flowchart showing an example of processing executed by the information processing apparatus 200. Note that in the example shown in FIG. 8, similarity between three-dimensional models is evaluated in two stages. In the first stage, similarity based on three-dimensional model bounding boxes is verified. A three-dimensional model bounding box used in the following example is the smallest cube surrounding an object area of a model. Such a three-dimensional model bounding box is used in object detection. Furthermore, in the second stage, similarity is verified using another method (e.g., comparison between pieces of three-dimensional point cloud data). By thus combining simple evaluation in the first stage and detailed evaluation in the second stage, the amount of processing in evaluation processing can be reduced.

However, a method of verification of similarity is not limited to the foregoing method. For example, it is not necessary to verify similarity based on three-dimensional model bounding boxes. As a specific method, the data analysis unit 212 can use a method of calculating a degree of similarity between point clouds, which is disclosed in Japanese Patent Laid-Open No. 2021-140535. Furthermore, evaluation may be performed in one stage, instead of performing evaluation in two stages.

In step S801, the data obtainment unit 210 obtains three-dimensional model data of the inspection target 211. As stated earlier, the data obtainment unit 210 can obtain the three-dimensional model data using a measurement apparatus, such as a 3D scanner, or a function of generating a three-dimensional model based on images from multiple viewpoints. In the present example, the three-dimensional model data of the inspection target 211 includes information of a three-dimensional point cloud representing the external shape of the inspection target 211.

In step S802, the data analysis unit 212 sets a three-dimensional model bounding box with respect to the three-dimensional model that is the inspection target 211, which has been obtained in step S801.

In step S803, the data analysis unit 212 specifies a sequence that is assumed to be in correspondence with the inspection target 211 among the sequences recorded in the information recording unit 143. As stated earlier, the data analysis unit 212 specifies a sequence that has been used by the image generation apparatus 100 to generate a virtual viewpoint image that is assumed to have been used to generate the inspection target 211.

In step S804, the data analysis unit 212 selects one of the time codes recorded in the information recording unit 143 in association with the sequence specified in step S803.

In step S805, the data analysis unit 212 reads out a virtual viewpoint parameter associated with the time code selected in step S804 from the information recording unit 143. Also, the data analysis unit 212 reads out a three-dimensional model corresponding to the time code selected in step S804 from the model recording unit 134.

In step S806, the data analysis unit 212 sets a three-dimensional model bounding box circumscribed about the three-dimensional model that has been read out from the model recording unit 134 in step S805.

In step S807, the data analysis unit 212 transforms the three-dimensional model bounding box set in step S802 so that it substantially matches the coordinates of the three-dimensional model bounding box set in step S806. Then, the data analysis unit 212 compares the discrete three-dimensional model bounding boxes with each other. In step S808, the data analysis unit 212 determines whether the vertex coordinates of the discrete three-dimensional model bounding boxes substantially match. For example, the data analysis unit 212 can determine that the vertex coordinates substantially match in a case where a sum total of distances between pairs of vertex coordinates is equal to or smaller than a threshold. In a case where it has been determined that the vertex coordinates substantially match, processing proceeds to step S809. Otherwise, processing proceeds to step S814.

In step S809, the data analysis unit 212 further compares the three-dimensional model that is the inspection target obtained in step S801 with the three-dimensional model obtained in step S805. The data analysis unit 212 can compare the pieces of three-dimensional model data using an existing method. In step S809, the data analysis unit 212 can use a comparison method different from the method of comparison between the three-dimensional model bounding boxes in step S807. For example, the data analysis unit 212 can compare pieces of point group data representing the respective three-dimensional models. In step S810, the data analysis unit 212 determines whether the three-dimensional models substantially match. In a case where it has been determined that the vertex coordinates substantially match, processing proceeds to step S811. Otherwise, processing proceeds to step S814.

In step S811, the data analysis unit 212 obtains, from the user information obtainment unit 141, a user ID of an operator who has issued an instruction for generating the virtual viewpoint image associated with the time code selected in step S804. In step S812, the result output unit 213 provides a notification indicating that there is a three-dimensional model which is similar to the three-dimensional model that is the inspection target and which has been used in generation of the virtual viewpoint image. In step S813, the result output unit 213 outputs the user ID obtained in step S811 and time information of the three-dimensional model used in generation of the virtual viewpoint image (e.g., the time code selected in step S804).

In step S814, the data analysis unit 212 determines whether the three-dimensional model that is the inspection target has been compared with the three-dimensional models corresponding to all time codes. In a case where the comparison with all three-dimensional models has not been completed, processing returns to step S804. In step S804, the data analysis unit 212 selects another one of the time codes recorded in the information recording unit 143 in association with the sequence specified in step S803. In a case where the comparison with all three-dimensional models has been completed, processing proceeds to step S815. In step S815, the result output unit 213 provides a notification indicating that there is no three-dimensional model which is similar to the three-dimensional model that is the inspection target and which has been used in generation of the virtual viewpoint image.

According to the above-described configuration, the information processing apparatus 200 can determine whether a three-dimensional shape created by a third party is a copy that has been made based on virtual viewpoint images generated by the image generation apparatus 100. Also, in a case where it has been determined that the three-dimensional shape created by the third party is the copy, the information processing apparatus 200 can output or record a user ID of an operator who has output a virtual viewpoint image and time information related to a three-dimensional model that has been used to generate the virtual viewpoint image.

Note that it is not indispensable to compare the three-dimensional models that respectively correspond to a plurality of time codes with a three-dimensional model that is an inspection target. In step S804, the data analysis unit 212 may select one time code in accordance with a setting configured by the user or automatically, as stated earlier. Then, the data analysis unit 212 may only compare a three-dimensional model corresponding to one time code with the three-dimensional model that is the inspection target.

Furthermore, in order to evaluate similarity between three-dimensional models, the data analysis unit 212 may use an image-based comparison technique. For example, the data analysis unit 212 can determine the front of the three-dimensional model that is the inspection target. Then, the data analysis unit 212 can arrange the three-dimensional model that is the inspection target in a virtual space so that it has the same orientation as the three-dimensional model that has been read out from the model recording unit 134. The image generation apparatus 100 can generate a virtual viewpoint image of the three-dimensional model that is the inspection target using the three-dimensional model that is the inspection target arranged in this way and the virtual viewpoint parameter that has been read out in step S805.

The data analysis unit 212 may compare the virtual viewpoint image based on the model data of the inspection target that has been generated in the foregoing manner with a virtual viewpoint image that has been generated by the image generation apparatus 100 before. In a case where these images are similar to each other, it can be determined that the three-dimensional model used in generation of the virtual viewpoint image is similar to the three-dimensional model that is the inspection target. Note that as stated earlier, a virtual viewpoint image generated by the image generation apparatus 100 can be stored in the image storage unit 144 in association with a sequence and a time code. The data analysis unit 212 may obtain the virtual viewpoint image generated by the image generation apparatus 100 from the image storage unit 144. On the other hand, the data analysis unit 212 may reconstruct a virtual viewpoint image that has been generated in the past using a three-dimensional model that is a comparison target. For example, the data analysis unit 212 can request the image generation apparatus 100 to generate a virtual viewpoint image based on the virtual viewpoint parameter and the three-dimensional model that have been read out in step S805. The virtual viewpoint image generated by the image generation apparatus 100 at this time is the same as the virtual viewpoint image generated in the past.

### (Example of Hardware Configuration)

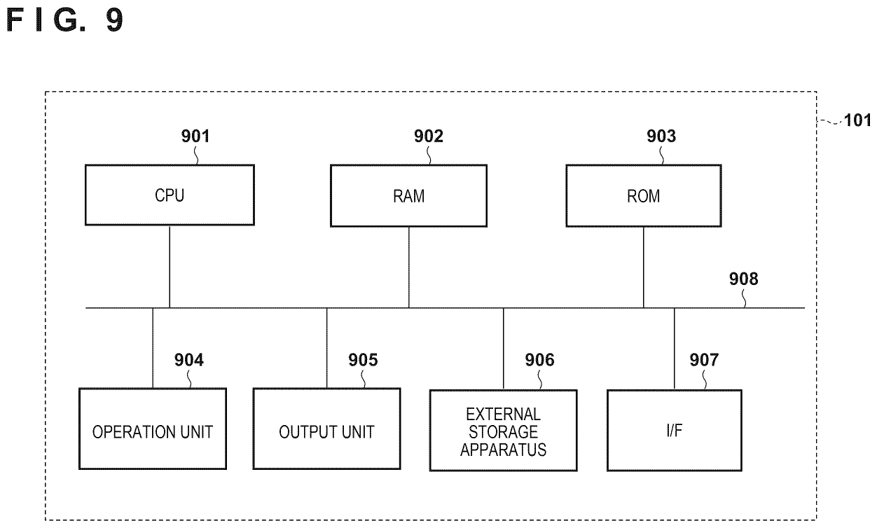

The above-described image generation apparatus 100, information processing apparatus 101, model generation apparatus 120, and information processing apparatus 200 can be realized by a computer that includes a processor and a memory. FIG. 9 is a block diagram showing an example of a hardware configuration of a computer that can be used as the information processing apparatus 101 as an example. Note that the image generation apparatus 100, the model generation apparatus 120, and the information processing apparatus 200 may be realized by using the computer shown in FIG. 9.

A CPU 901 controls the entire computer using a computer program or data recorded in a RAM 902 or a ROM 903. Also, the CPU 901 executes each type of processing that has been described to be executed by the information processing apparatus 101 above. That is to say, the CPU 901 can function as each processing unit shown in FIG. 1.

The RAM 902 includes an area that temporarily stores the computer program or data read from the external storage apparatus 906, data obtained from the outside via an interface (I/F) 907, or the like. Furthermore, the RAM 902 includes a working area that is used when the CPU 901 executes various types of processing. The RAM 902 can be allocated as, for example, a frame memory. In addition, the RAM 902 can store various types of data, such as data stored in the model recording unit 134, the information recording unit 143, and the image storage unit 144. Moreover, virtual viewpoint images or determination results output from each processing unit may be recorded in the RAM 902. Setting data, a boot program, or the like of the computer can be recorded in the ROM 903.

An operation unit 904 is used by a user to input instructions. The operation unit 904 is, for example, a keyboard or a mouse. Various types of instructions can be input to the CPU 901 by the user of the computer operating the operation unit 904. An output unit 905 is used to output information. The output unit 905 is, for example, a liquid crystal display. The output unit 905 can display a processing result obtained by the CPU 901. The operation unit 904 and the output unit 905 are not necessarily required. For example, instructions may be input and information may be output using an apparatus connected via the I/F 907.

An external storage apparatus 906 is a large-capacity information storage apparatus. The external storage apparatus 906 is, for example, a hard disk drive apparatus. The external storage apparatus 906 can store a computer program for causing the CPU 901 to realize an operating system (OS) and the functions of each unit shown in FIG. 1. Furthermore, the external storage apparatus 906 may store various types of image data used in processing. Note that the data that has been described to be recorded in the model recording unit 134 or the information recording unit 143 may be stored in the external storage apparatus 906. The computer program or data stored in the external storage apparatus 906 is loaded to the RAM 902 under control of the CPU 901 and is used by the CPU 901.

A network, such as a LAN and the Internet, or another device, such as a projection apparatus and a display apparatus, can be connected to the I/F 907. This computer can obtain or transmit various types of information via the I/F 907. A bus 908 connects between the discrete units described above.

As described above, the functions of each unit shown in FIG. 1 can be realized by a processor, like the CPU 901, executing a program stored in a memory, such as the RAM 902, the ROM 903, and the external storage apparatus 906. For example, the CPU 901 can play a central role in controlling the operations according to the above-described embodiment. Note that a part or all of the functions included in the image generation apparatus 100, the information processing apparatus 101, the model generation apparatus 120, and the information processing apparatus 200 shown in FIG. 2 may be realized by dedicated hardware. Also, an information processing system, an image generation apparatus, an information processing apparatus, or a model generation apparatus according to an embodiment may be composed of, for example, a plurality of information processing apparatuses connected via a network. On the other hand, the functions of two or more of the image generation apparatus 100, the information processing apparatus 101, the model generation apparatus 120, and the information processing apparatus 200 may be realized by a single apparatus.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the embodiments are not limited to the disclosed exemplary embodiments. The scope of the following claims is to be accorded the broadest interpretation so as to encompass all such modifications and equivalent structures and functions.

This application claims the benefit of Japanese Patent Application No. 2024-002795, filed Jan. 11, 2024, which is hereby incorporated by reference herein in its entirety.

What is claimed is:

1. An information processing system comprising one or more memories storing instructions and one or more processors that execute the instructions to:
obtain three-dimensional models of one or more objects at a designated time from a storage that stores three-dimensional models indicating three-dimensional shapes of objects at respective times;
using the three-dimensional models of the one or more objects at the designated time, generate a virtual viewpoint image corresponding to the designated time from a virtual viewpoint based on a designated virtual viewpoint parameter;
output the generated virtual viewpoint image;
determine whether a predetermined condition is satisfied, the predetermined condition being a condition related to at least one of the time and the virtual viewpoint parameter; and
in response to satisfaction of the predetermined condition, record information on the three-dimensional models of the objects corresponding to the generated virtual viewpoint image.

2. The information processing system according to claim 1, wherein the one or more processors execute the instructions to record at least one of the time and the virtual viewpoint parameter as information used to specify the three-dimensional models of the objects.

3. The information processing system according to claim 1, wherein the storage stores sequence data indicating three-dimensional models that respectively pertain to a plurality of times with respect to one or more objects, and
the one or more processors execute the instructions to record information that specifies the sequence data used to generate the virtual viewpoint image as information on the three-dimensional models of the objects.

4. The information processing system according to claim 1, wherein the one or more processors execute the instructions to record at least a part of the generated virtual viewpoint image.

5. The information processing system according to claim 1, wherein the one or more processors execute the instructions to record user information of a user who has issued an instruction for generating the virtual viewpoint image.

6. The information processing system according to claim 1, wherein the virtual viewpoint parameter includes at least one of a location and an orientation of the virtual viewpoint.

7. The information processing system according to claim 1, wherein the one or more processors execute the instructions to determine whether the predetermined condition is satisfied based on at least one of a relationship between the times that respectively pertain to two or more generated virtual viewpoint images, and a relationship between the virtual viewpoint parameters that respectively pertain to the two or more virtual viewpoint images.

8. The information processing system according to claim 1, wherein the predetermined condition includes a condition related to an interval between the times that pertain to two virtual viewpoint images.

9. The information processing system according to claim 1, wherein the predetermined condition includes a condition related to the number of specific pairs of virtual viewpoint images among a plurality of generated virtual viewpoint images, and with regard to each of the specific pairs of virtual viewpoint images, an interval between the times is smaller than a threshold.

10. The information processing system according to claim 1, wherein the predetermined condition includes a condition related to the number of virtual viewpoint images corresponding to times included in a predetermined time range among a plurality of generated virtual viewpoint images.

11. The information processing system according to claim 1, wherein the predetermined condition includes a condition related to a relationship between locations of virtual viewpoints that respectively pertain to two or more generated virtual viewpoint images.

12. The information processing system according to claim 1, wherein the predetermined condition includes a condition related to similarity between gaze points or areas within fields of view of virtual viewpoints that respectively pertain to two or more generated virtual viewpoint images.

13. The information processing system according to claim 1, wherein the one or more processors execute the instructions to, in response to satisfaction of the predetermined condition, record log information indicating that the virtual viewpoint image has been generated using the three-dimensional models of the objects at the time.

14. An information processing system comprising one or more memories storing instructions and one or more processors that execute the instructions to:
obtain a three-dimensional model that is an inspection target;
with reference to a record of generation of a virtual viewpoint image, obtain, as a three-dimensional model that is a comparison target, a three-dimensional model that has been used to generate the virtual viewpoint image in the past from a storage that stores three-dimensional models indicating three-dimensional shapes of objects; and
compare the three-dimensional model that is the inspection target with the three-dimensional model that is the comparison target.

15. The information processing system according to claim 14, wherein
the one or more processors execute the instructions to store three-dimensional models that respectively pertain to a plurality of times with respect to one or more objects,
the record of generation of the virtual viewpoint image includes at least one of the time and a virtual viewpoint parameter corresponding to the virtual viewpoint image, and
the one or more processors execute the instructions to obtain the three-dimensional model that has been used to generate the virtual viewpoint image in the past with reference to at least one of the time and the virtual viewpoint parameter corresponding to the virtual viewpoint image.

16. The information processing system according to claim 14, wherein the one or more processors execute the instructions to reconstruct the virtual viewpoint image that has been generated in the past using the three-dimensional model that is the comparison target.

17. The information processing system according to claim 14, wherein the record of generation of the virtual viewpoint image is information recorded by the information processing system comprising one or more memories storing instructions and one or more processors that execute the instructions to:
obtain three-dimensional models of one or more objects at a designated time from a storage that stores three-dimensional models indicating three-dimensional shapes of objects at respective times;
using the three-dimensional models of the one or more objects at the designated time, generate a virtual viewpoint image corresponding to the designated time from a virtual viewpoint based on a designated virtual viewpoint parameter;
output the generated virtual viewpoint image;
determine whether a predetermined condition is satisfied, the predetermined condition being a condition related to at least one of the time and the virtual viewpoint parameter; and
in response to satisfaction of the predetermined condition, record information on the three-dimensional models of the objects corresponding to the generated virtual viewpoint image.

18. An information processing method comprising:
obtaining three-dimensional models of one or more objects at a designated time from a storage that stores three-dimensional models indicating three-dimensional shapes of objects at respective times;
with use of the three-dimensional models of the one or more objects at the designated time, generating a virtual viewpoint image corresponding to the designated time from a virtual viewpoint based on a designated virtual viewpoint parameter;
outputting the generated virtual viewpoint image;
determining whether a predetermined condition is satisfied, the predetermined condition being a condition related to at least one of the time and the virtual viewpoint parameter; and
in response to satisfaction of the predetermined condition, recording information on the three-dimensional models of the objects corresponding to the generated virtual viewpoint image.

19. A non-transitory computer-readable medium storing a program executable by a computer to perform a method comprising:
obtaining three-dimensional models of one or more objects at a designated time from a storage that stores three-dimensional models indicating three-dimensional shapes of objects at respective times;
with use of the three-dimensional models of the one or more objects at the designated time, generating a virtual viewpoint image corresponding to the designated time from a virtual viewpoint based on a designated virtual viewpoint parameter;
outputting the generated virtual viewpoint image;
determining whether a predetermined condition is satisfied, the predetermined condition being a condition related to at least one of the time and the virtual viewpoint parameter; and
in response to satisfaction of the predetermined condition, recording information on the three-dimensional models of the objects corresponding to the generated virtual viewpoint image.
